(19) United States
(12) Patent Application Publication
(10) Pub. No.: US 2024/0214507 A1
(43) Pub. Date: Jun. 27, 2024

(54) COMMUNICATION CONTROL APPARATUS, COMMUNICATION APPARATUS, COMMUNICATION SYSTEM, COMMUNICATION METHOD, AND STORAGE MEDIUM

(71) Applicant: CANON KABUSHIKI KAISHA, Tokyo (JP)

(72) Inventor: SATORU TSUBOI, Kanagawa (JP)

(21) Appl. No.: 18/393,276

(22) Filed: Dec. 21, 2023

(30) Foreign Application Priority Data
Dec. 23, 2022 (JP) 2022-206110

(51) Int. Cl. H04N 5/073

(52) U.S. Cl. CPC H04N 5/0733

(57) ABSTRACT

A communication control apparatus includes a generation unit, a receiving unit, a first sending unit configured to cause a first image packet received by the receiving unit to be sent by a first communication interface included in a plurality of communication interfaces, a second sending unit configured to cause a second image packet generated by the generation unit to be sent by the first communication interface at timing that is based on reception of predetermined information included in the first image packet, and a control unit configured to, in a case where the first communication interface has become unable to perform sending during sending of the first image packet or the second image packet from the first communication interface, cause a communication packet including at least the predetermined information to be sent by a second communication interface included in the plurality of communication interfaces.

### BACKGROUND

### Field of the Disclosure

Aspects of the present disclosure generally relate to a communication control apparatus, a communication apparatus, a communication system, a communication method, and a storage medium.

### Description of the Related Art

Recently, there has been proposed a system which performs image capturing of a subject from a plurality of directions with a plurality of cameras.

For example, Japanese Patent Application Laid-Open No. 2017-211827 discusses a system which generates a virtual viewpoint image of a subject based on captured images obtained by a plurality of cameras, which performs image capturing of the subject from a plurality of directions. In this system, a plurality of camera adapters is interconnected in a daisy chain configuration. Then, pieces of image data created by the respective camera adapters are sequentially transmitted between the camera adapters, so that, finally, all of the pieces of image data created by the respective camera adapters are transmitted to a front-end server.

However, in a case where a breakdown in communication with regard to a communication interface has occurred in an apparatus which is transmitting image data, not only image data which is being transmitted by the apparatus in which the breakdown in communication has occurred but also pieces of image data generated by the respective apparatuses located downstream of the apparatus may become unable to be transmitted.

### SUMMARY

Aspects of the present disclosure are generally directed to, even in a case where a breakdown in communication has occurred in an apparatus located on an upstream side, enabling image data generated by an apparatus located on a downstream side to be transmitted.

According to an aspect of the present disclosure, a communication control apparatus includes a generation unit configured to generate an image packet, a receiving unit configured to receive an image packet, a first sending unit configured to cause a first image packet received by the receiving unit to be sent by a first communication interface included in a plurality of communication interfaces, a second sending unit configured to cause a second image packet generated by the generation unit to be sent by the first communication interface at timing that is based on reception of predetermined information included in the first image packet, and a control unit configured to, in a case where the first communication interface has become unable to perform sending during sending of the first image packet or the second image packet from the first communication interface, cause a communication packet including at least the predetermined information to be sent by a second communication interface included in the plurality of communication interfaces.

Further features of the present disclosure will become apparent from the following description of exemplary embodiments with reference to the attached drawings.

### BRIEF DESCRIPTION OF THE DRAWINGS

FIG. 1 is a system configuration diagram of a synchronous image capturing system according to one or more aspects of the present disclosure.

FIG. 2 is a diagram illustrating an example of transmission of image packets in the synchronous image capturing system.

FIG. 3 is a diagram used to explain problems occurring in a comparative example.

FIG. 4 is a diagram illustrating an internal configuration of a camera adapter in the first exemplary embodiment.

FIG. 5 is a functional block diagram illustrating an internal function of a transmission unit.

FIG. 6 is a flowchart illustrating control processing for the transmission unit which is performed by a central processing unit (CPU).

FIG. 7 is a flowchart illustrating an anterior half of processing operations concerning generation and sending of an image packet.

FIG. 8 is a flowchart illustrating a posterior half of processing operations concerning generation and sending of an image packet.

FIG. 9 is a flowchart illustrating processing operations concerning transfer of a received image packet.

### DESCRIPTION OF THE EMBODIMENTS

Various exemplary embodiments, features, and aspects of the disclosure will be described in detail below with reference to the drawings. Furthermore, the following exemplary embodiments are not intended to limit the present disclosure, and not all of the combinations of features described in the exemplary embodiments are necessarily essential for solutions in the present disclosure. Configurations of the exemplary embodiments can be modified or altered as appropriate according to specifications and various conditions (such as use conditions or use environments) of a system or apparatus to which the present disclosure is applied. The technical scope of the present disclosure is defined by claims and should not be construed to be defined by the following individual exemplary embodiments.

In the following description, constituent elements illustrated in the figures earlier referred to are referred to as appropriate in the description of the figures later referred to.

### Configuration of Synchronous Image Capturing System

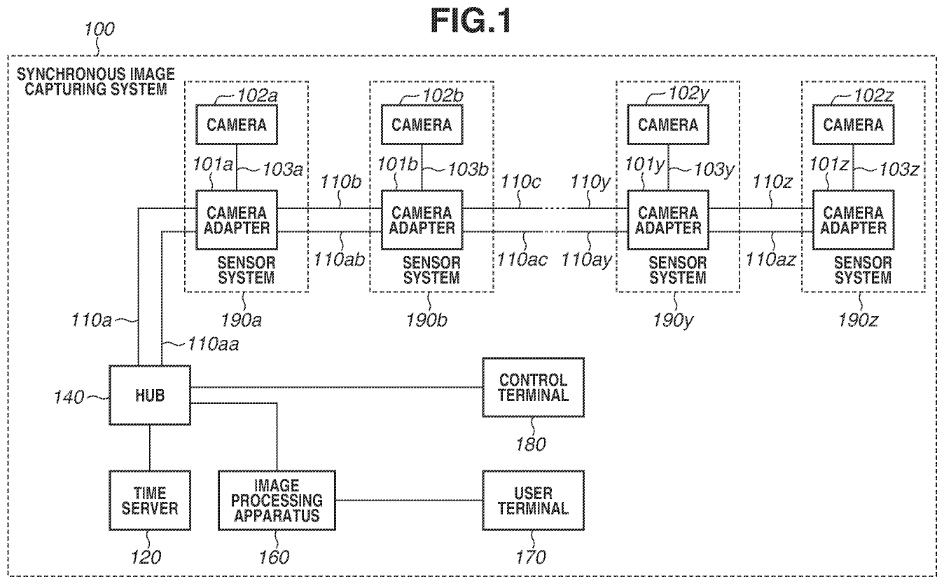

FIG. 1 is a system configuration diagram of a synchronous image capturing system in a first exemplary embodiment.

The synchronous image capturing system 100 is a system which performs image capturing with a plurality of cameras installed in a facility such as an athletic field (stadium) or a concert hall. The synchronous image capturing system 100 includes sensor systems 190a to 190z, an image processing apparatus 160, a user terminal 170, a control terminal 180, and a hub 140. A network is formed by these elements in the synchronous image capturing system 100, and the hub 140 has a routing function for communication packets.

In the following description, in the case of collectively referring to similar elements which are distinguished by alphabet of a suffix attached to each reference character, the reference character may be used with the suffix omitted therefrom. For example, the sensor systems 190a to 190z for twenty-six sets may be collectively referred to as a “sensor system 190”.

The control terminal 180 performs management of operating conditions and parameter setting control with respect to each element of the synchronous image capturing system 100 via a network. Here, the network can be Gigabit Ethernet (1 GbE), 10 Gigabit Ethernet (10 GbE), or 100 Gigabit Ethernet (100 GbE), which is compliant with the IEEE standard for Ethernet. Moreover, the network can also be configured with a combination of, for example, Interconnect (InfiniBand) and Industrial Ethernet. Moreover, the network is not limited to these, but can also be another type of network.

Each sensor system 190 includes a camera 102 and a camera adapter 101, so that an image captured by the camera 102 is input to the image processing apparatus 160 via the network. The image processing apparatus 160 processes the input image to generate a virtual viewpoint image. The user terminal 170 is operated by the user to designate a viewpoint for the image processing apparatus 160, so that the virtual viewpoint image is displayed on a display screen of the user terminal 170.

While the synchronous image capturing system 100 includes, for example, sensor systems 190a to 190z for twenty-six sets, the number of sets is not limited to this. Moreover, a plurality of sensor systems 190 does not need to have the same configuration but can be configured with, for example, respective different models of apparatuses. Furthermore, in the description of the first exemplary embodiment, unless otherwise stated, the term “image” is assumed to include the concepts of a moving image and a still image. Thus, the synchronous image capturing system 100 in the first exemplary embodiment is assumed to be able to process both a still image and a moving image.

The sensor systems 190a to 190z included in the synchronous image capturing system 100 are connected by daisy chains, and the connection is formed in a doubled form. A daisy chain in which a first 0-system network cable 110a to a twenty-sixth 0-system network cable 110z are connected forms a 0-system path. Moreover, a daisy chain in which a first 1-system network cable 110aa to a twenty-sixth 1-system network cable 110az are connected forms a 1-system path.

In a network in which a plurality of sensor systems 190a to 190z is connected, the side thereof close to the hub 140 is referred to as a “root side”, and the side thereof far from the hub 140 is referred to as a “leaf side”. Moreover, even in each sensor system 190 or each camera adapter 101, the side thereof close to the hub 140 is referred to as a “root side”, and the side thereof far from the hub 140 is referred to as a “leaf side”.

Since the synchronous paths connected by daisy chains are configured in a doubled form, even if a failure occurs in one of the synchronous paths, it becomes possible to maintain synchronization in the synchronous image capturing system 100.

While, in FIG. 1, a configuration in which all of the sensor systems 190a to 190z for twenty-six sets are connected in a daisy chain configuration is illustrated, the connection form in the synchronous image capturing system 100 is not limited to this. For example, a plurality of sensor systems 190 can be divided into some groups, and sensor systems 190 can be connected in a daisy chain configuration for each of the groups obtained by division.

Such a configuration is especially effective in, for example, a stadium. For example, there is conceivable a case where the stadium is configured with a plurality of floors and a daisy chain of sensor systems 190 is installed in each floor. In this case, it is possible to perform inputting to the image processing apparatus 160 for each floor or for each semiperimeter of the stadium. Accordingly, even in a place in which it is difficult to install wiring for connecting all of the sensor systems 190 in one daisy chain, it is possible to attain the simplification of installation and the flexibility of systems.

As mentioned above, each sensor system 190 includes a camera 102 and a camera adapter 101. Thus, the synchronous image capturing system 100 includes a plurality of (for example, twenty-six) cameras 102 for performing image capturing of a subject from a plurality of directions. Furthermore, the plurality of cameras 102 included in the synchronous image capturing system 100 can be different from each other in performance or model.

Moreover, each sensor system 190 is not limited to a configuration which includes a camera 102 and a camera adapter 101, but can include, for example, an audio device such as a microphone or a tripod head for controlling the orientation of the camera. Moreover, for example, the sensor system 190 can be configured with one camera adapter 101 and a plurality of cameras 102, or can be configured with one camera 102 and a plurality of camera adapters 101. Thus, a plurality of cameras 102 and a plurality of camera adapters 101 included in the synchronous image capturing system 100 are associated with each other in an N-to-M relationship (each of N and M being an integer of 1 or more).

While, in FIG. 1, only one connection 103 between the camera 102 and the camera adapter 101 is illustrated, the number of connections 103 is not limited to this. There is a case where a plurality of connections 103, such as a signal line for controlling the camera 102 and a signal line for transmitting data obtained by the camera 102 performing image capturing, is provided.

Moreover, the camera 102 and the camera adapter 101 can be configured in an integrated manner. Additionally, at least a part of the functions of the camera adapter 101 can be included in the image processing apparatus 160. Furthermore, in the following description, a case where each sensor system 190 includes only one of cameras 102 of the same type and only one of camera adapters 101 of the same type is illustrated as an example.

### Generation of Virtual Viewpoint Image

The camera adapter 101 of each sensor system 190 sends an image obtained by image capturing performed by the camera 102 in the form of an image packet containing image data to the image processing apparatus 160 via a daisy chain connection.

The connection form in which the sensor systems 190 are connected in a daisy chain configuration enables the reduction of the number of connection cables or the work saving of wiring operation in the increased large capacity of image data caused by the increased high resolution to, for example, 4K or 8K or the increased high frame rate of a captured image.

Control of image processing in the image processing apparatus 160 is switched depending on whether the number of camera adapters 101 located at one end of the side of the image processing apparatus 160 in a daisy chain connection is one or plural. Thus, control in the image processing apparatus 160 is switched depending on whether the sensor systems 190 are divided into a plurality of groups.

A camera adapter 101 located at one end of the side of the image processing apparatus 160 in a daisy chain connection relays an image sent from the camera adapter 101 of another sensor system 190 connected in a daisy chain configuration and inputs the image to the image processing apparatus 160.

In a case where the number of camera adapters 101 which perform image inputting is one, since the athletic-field entire-perimeter image is generated while image transmission is being performed in a daisy chain connection, the timing at which the entire-perimeter image becomes complete in the image processing apparatus 160 is synchronized. Thus, unless the sensor systems 190 are divided into groups, synchronization is attained.

However, if the number of camera adapters 101 which perform image inputting is plural, there is conceivable a case where a delay from when an image is captured to when the image is input to the image processing apparatus 160 differs for each lane (path) of the daisy chain. Thus, in a case where the sensor systems 190 are divided into groups, the timing at which the entire-perimeter image is input to the image processing apparatus 160 may not be synchronized. Therefore, it is necessary for the image processing apparatus 160 to perform image processing while checking concentration of images by synchronous control which takes synchronization after waiting until the entire-perimeter image becomes complete.

In each lane of the daisy chain, for example, an image captured by the camera 102z of the twenty-sixth sensor system 190z is subjected to image processing by the camera adapter 101z and is then packetized. The image packetized by the twenty-sixth sensor system 190z is transmitted to the camera adapter 101y of the twenty-fifth sensor system 190y via one of the network cables 110z and 110az of the 0-system and 1-system daisy chains. The packetized image is transmitted as an image packet.

The twenty-fifth sensor system 190y transfers an image packet received from the twenty-sixth sensor system 190z to the twenty-fourth sensor system 190x on the downstream side. Moreover, the twenty-fifth sensor system 190y performs image processing on an image captured by the camera 102y, and then packetizes the processed image into an image packet and sends the image packet to the twenty-fourth sensor system 190x.

With the above-described operation performed in each sensor system 190, image packets of images acquired by the respective sensor systems 190 are transmitted from the first sensor system 190a to the hub 140, and are then transmitted to the image processing apparatus 160.

The image processing apparatus 160 performs processing of an image captured by each sensor system 190 and transmitted therefrom. First, the image processing apparatus 160 reconstructs an image from the transmitted image packet. The reconstruction of an image is performed with use of, for example, a camera adapter identifier (ID), an image type, and a frame number included in header information about the image packet. Moreover, the image processing apparatus 160 stores the image while associating the image with such pieces of information.

The image processing apparatus 160 receives the designation of a viewpoint from the user terminal 170, reads out a corresponding image from the stored information based on the designated viewpoint, and performs rendering processing on the image to generate a virtual viewpoint image. Furthermore, at least a part of the functions of the image processing apparatus 160 can be included in the control terminal 180, the sensor system 190, or the user terminal 170.

The virtual viewpoint image generated by rendering processing is sent from the image processing apparatus 160 to the user terminal 170 and is displayed on a display screen of the user terminal 170. A user who operates the user terminal 170 is allowed to view an image with a viewpoint thereof designated.

Thus, the image processing apparatus 160 generates virtual viewpoint content that is based on captured images acquired by a plurality of cameras 102 (plural viewpoint images) and viewpoint information.

Furthermore, while, in the present exemplary embodiment, virtual viewpoint content is assumed to be generated by the image processing apparatus 160, virtual viewpoint content can be generated by the control terminal 180 or the user terminal 170.

### Synchronization of Time

A time server 120 has the function of delivering time. Specifically, the time server 120 delivers time to each sensor system 190 with use of a synchronous packet, which is a communication packet used for performing time synchronization in the sensor system 190. The camera adapter 101 performs sending and receiving of a synchronous packet via either one of doubled daisy chains. The camera adapter 101 genlocks the camera 102 based on time information included in the synchronous packet, thus performing synchronization in image frame between the cameras 102.

The camera adapter 101 has a Transparent Clock function and an Ordinary Clock function in Precision Time Protocol (PTP). Specifically, when transferring the received synchronous packet, the camera adapter 101 calculates a staying time of the synchronous packet within a terminal and appends the calculated staying time to the synchronous packet. Then, the camera adapter 101 transfers the synchronous packet to a subsequent camera adapter 101, and the camera adapter 101 itself becomes synchronized with time of the time server 120 based on the received synchronous packet.

Each of all the camera adapters 101 included in the synchronous image capturing system 100 has the above-mentioned two functions, thus becoming able to be time-synchronized with the time server 120 with a high degree of accuracy. Then, a plurality of camera adapters 101 which has been time-synchronized based on the time server 120 becomes able to synchronize image capturing timings of the cameras 102 with each other. Furthermore, the hub 140 has the Transparent Clock function in the PTP.

Since, if a failure occurs in the time server 120, the synchronous image capturing system 100 breaks down, a plurality of time servers 120 can be arranged to employ redundancy.

In a case where redundancy has been employed, to cause respective times of the time servers 120 to become uniform, synchronization between the time servers 120 is performed with use of, for example, the Global Positioning System (GPS).

### Transmission of Image Packets

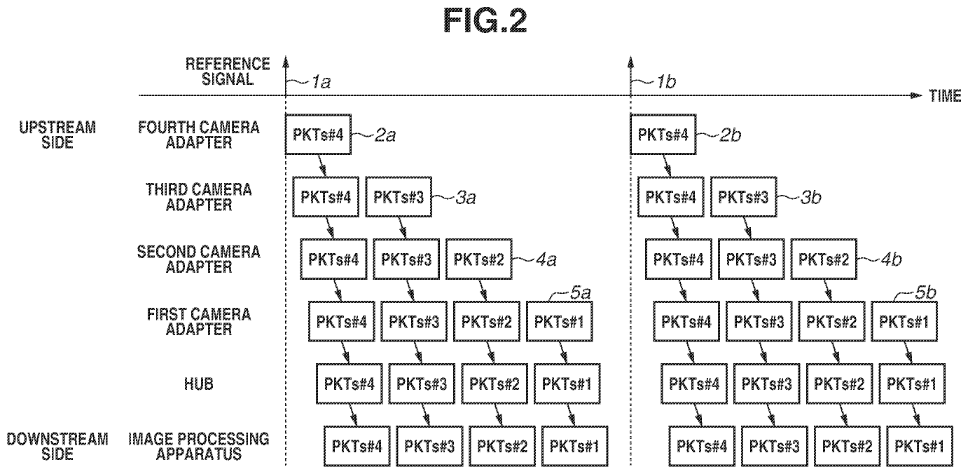

FIG. 2 is a diagram illustrating an example of transmission of image packets in the synchronous image capturing system 100.

However, for the convenience of explanation, a case where the synchronous image capturing system 100 includes four camera adapters 101 is illustrated.

With respect to all of the camera adapters 101, time synchronization is performed according to the PTP, and image capturing is performed in synchronization with reference signals 1a and 1b of the same timing which are generated in each camera adapter 101.

Image packets 2a to 5a and 2b to 5b for foreground images each of which is obtained by clipping a subject portion, such as a human body, from an image acquired by image capturing are transmitted to the image processing apparatus 160 in order from the most upstream, fourth, camera adapter 101 beginning at the reference signals 1a and 1b. Furthermore, while, in FIG. 2, each of the image packets 2a to 5a and 2b to 5b is shown by a single block, each of the actual image packets 2a to 5a and 2b to 5b is a packet group including one or more image packets. Thus, the respective camera adapters 101 divide captured images as needed, load the images on respective packet groups, and sequentially perform packet sending until all of the pieces of image data are completely sent.

The third camera adapter 101 starts generation and sending of image packets 3a and 3b for the third camera adapter 101 itself in the wake of start instruction information included in image packets 2a and 2b received from the fourth camera adapter 101 adjacent on the upstream side.

In a similar way, the second camera adapter 101 starts generation and sending of image packets 4a and 4b in the wake of start instruction information included in image packets 3a and 3b generated by the third camera adapter 101. The first camera adapter 101 starts generation and sending of image packets 5a and 5b in the wake of start instruction information included in image packets 4a and 4b generated by the second camera adapter 101.

In this way, in the camera adapters 101 which receive image packets 2a to 4a and 2b to 4b from the respective upstream sides, generation and sending of image packets 3a to 5a and 3b to 5b are performed in the wake of start instruction information. As a result, the image packets 2a to 5a and 2b to 5b are transmitted to the image processing apparatus 160 via the hub 140.

Furthermore, in FIG. 2, for descriptive purposes, the fourth camera adapter 101 is illustrated as starting generation and sending of the image packets 2a and 2b at timing coinciding with the reference signals 1a and 1b.

However, actually, since an image processing latency in the camera adapters 101 or an image capturing latency of the camera 102 occurs, the image packets 2a and 2b are sent at timing later than the reference signals 1a and 1b.

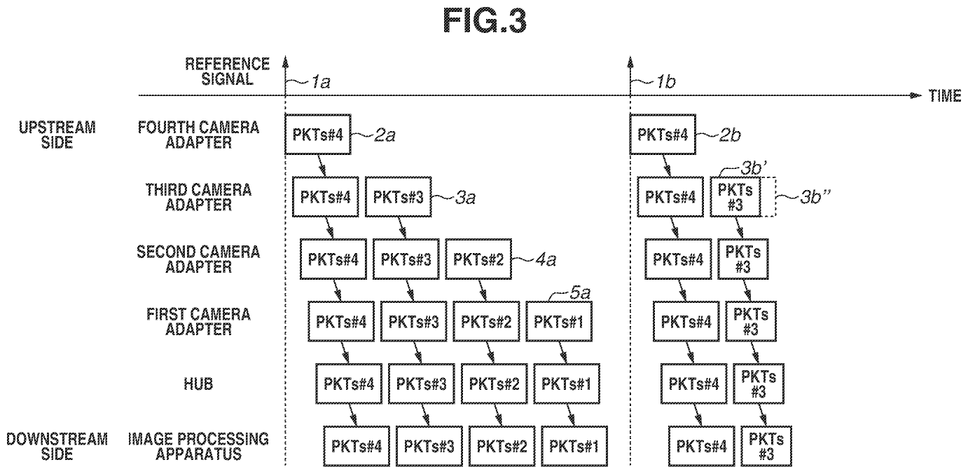

FIG. 3 is a diagram used to explain problems occurring in a comparative example.

Even in the comparative example, as with the synchronous image capturing system 100 in the present exemplary embodiment, image packets 2a to 5a generated by the respective camera adapters 101 are transmitted to the image processing apparatus in order from the most upstream, fourth, camera adapter 101. In FIG. 3, a case where an abnormality such as link-down has occurred during sending of an image packet 3b generated by the third camera adapter 101 is illustrated.

The third camera adapter 101 is able to send one part of an image associated with the reference signal 1b as an image packet 3b′ but the other part of the image as an image packet 3b′ is currently unable to be sent due to the abnormality of the communication interface. The image packet 3b′ which is currently unable to be sent includes an image packet containing start instruction information, so that, in the case of the comparative example, start instruction information is not able to be sent to the downstream side.

Therefore, the second camera adapter 101 is able to transfer the image packets 2b and 3b′ received from the third camera adapter 101, but is unable to perform generation and sending of an image packet by the second camera adapter 101 itself. Accordingly, the second camera adapter 101 is also unable to send an image packet containing start instruction information to the downstream side, and, in a chain reaction, the respective camera adapters 101 on the downstream side also become unable to perform generation and sending of image packets by the camera adapters 101 themselves.

Thus, in the comparative example, if the sending impossibility caused by, for example, link-down occurs in any one of a plurality of camera adapters 101, the respective camera adapters 101 on the downstream side become unable to perform generation and sending of image packets by the camera adapters 101 themselves. As a result, the amount of information arriving at the image processing apparatus 160 decreases, so that the deterioration of image quality of virtual viewpoint content which the image processing apparatus 160 generates with use of images associated with the reference signal 1b occurs.

Unlike the above-mentioned comparative example, in the synchronous image capturing system 100 in the present exemplary embodiment, even on the downstream side of the camera adapter 101 in which the sending impossibility has occurred, it becomes possible to perform generation and sending of image packets as described below.

### Configuration of Camera Adapter

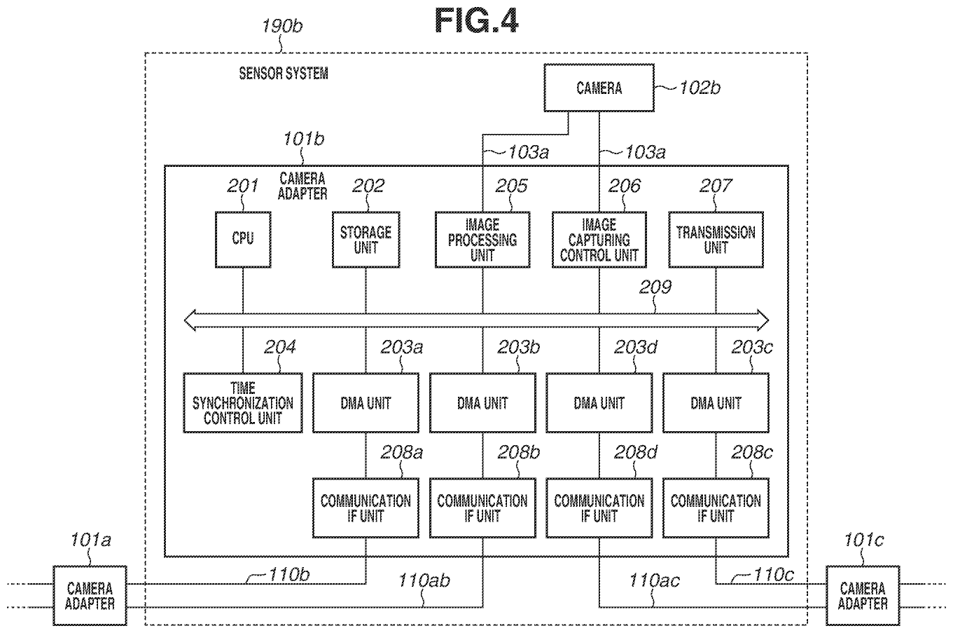

FIG. 4 is a diagram illustrating an internal configuration of the camera adapter 101 in the present exemplary embodiment. Furthermore, in FIG. 4, an internal configuration of the second camera adapter 101b is illustrated as a representative of each camera adapter 101.

The camera adapter 101 includes a central processing unit (CPU) 201, a storage unit 202, direct memory access (DMA) units 203a to 203d, and a time synchronization control unit 204. Additionally, the camera adapter 101 includes an image processing unit 205, an image capturing control unit 206, a transmission unit 207, communication interface (IF) units 208a to 208d, and a system bus 209.

The CPU 201, which is a processing unit which controls the entire camera adapter 101, performs exchange of a synchronous packet with the time server 120 and performs exchange of a control packet with the control terminal 180.

The storage unit 202 is a memory which retains, for example, a program for the CPU 201 and a synchronous packet and a control packet to be sent or received. Moreover, the storage unit 202 also retains image data generated by the image processing unit 205 performing, for example, image processing on captured image data received from the camera 102. While, in FIG. 4, the storage unit 202 is illustrated with a single block, a plurality of storage units 202 can be provided depending on the intended use. Moreover, in a case where a plurality of storage units 202 is provided, the respective storage units 202 can differ in memory types.

The DMA units 203a to 203d perform direct memory access (DMA) for sending and receiving of packets. The DMA units 203a to 203d perform DMA according to a transfer instruction received from the CPU 201 or the transmission unit 207. A transfer instruction regarding an image packet is issued by the transmission unit 207, and a transfer instruction regarding a synchronous packet is issued by the CPU 201.

In DMA for packet sending, the DMA units 203a to 203d read out image packets from the designated areas of the storage unit 202, and output the read-out image packets to the corresponding communication IF units 208a to 208d. In DMA for packet reception, the DMA units 203a to 203d transfer image packets received from the corresponding communication IF units 208a to 208d to the respective designated areas of the storage unit 202. Furthermore, each DMA unit 203 is able to perform buffering of a plurality of transfer instructions.

The communication IF units 208a to 208d assume processing of Layer 1 and Layer 2 of the Open Systems Interconnection (OSI) reference model, and perform sending and receiving of communication packets with an apparatus located outside the camera adapter 101. The communication packets to be sent and received include, for example, a synchronous packet, a Transmission Control Protocol/Internet Protocol (TCP/IP) packet, and an image packet.

As the communication IF units 208a to 208d, 0-system communication IF units 208a and 208c and 1-system communication IF units 208b and 208d are provided, so that, if, for example, link-down occurs in one of the 0-system and 1-system, switching to the other of the 0-system and 1-system is performed. In the following description, a communication IF unit 208 available before the switching may be referred to as a “first communication IF unit 208”, and a communication IF unit 208 available after the switching may be referred to as a “second communication IF unit 208”.

A synchronous packet which the time server 120 sends is received by the communication IF units 208a and 208b on the root side via the camera adapter 101a on the root side. Then, the synchronous packet is transferred to the storage unit 202 by the DMA units 203a and 203b on the root side according to a transfer instruction generated by the CPU 201.

Moreover, the synchronous packet is internally subjected to protocol processing and is then transmitted to the adjacent camera adapter 101c on the leaf side via the DMA units 203c and 203d and the communication IF units 208c and 208d on the leaf side according to an instruction from the CPU 201.

In a similar way, a synchronous packet which each camera adapter 101 on the leaf side sends to the time server 120 is received via the communication IF units 208c and 208d and the DMA units 203c and 203d on the leaf side and is then transferred to the storage unit 202.

Then, the synchronous packet, after being subjected to protocol processing, is transferred from the storage unit 202 to the DMA units 203a and 203b and the communication IF units 208a and 208b on the root side according to an instruction from the CPU 201, and is finally transmitted to the time server 120.

A synchronous packet which the camera adapter 101 itself generates is also stored in the storage unit 202 in a similar way, is sent to the camera adapter 101 on the root side via the DMA units 203a and 203b and the communication IF units 208a and 208b on the root side, and is then transmitted to the time server 120.

Sending and receiving of an image packet are described below.

Furthermore, the communication IF unit 208 internally includes a clock and has a time stamp function of retaining time of the internal clock when having sent or received a synchronous packet. The CPU 201 uses the time stamp function for calculation of time synchronization. The time stamp function enables accurately determining sending or receiving time of a synchronous packet and a time in which a synchronous packet is staying within the camera adapter 101b.

To measure an accurate staying time of a synchronous packet, the clocks of the communication IF units 208a to 208d are synchronized in time with each other before time synchronization using the PTP is started. A time difference from the time server 120 which is determined by protocol processing using the PTP is applied to all of the clocks of the communication IF units 208a to 208d, so that the communication IF units 208a to 208d are controlled by the CPU 201 in such a way as to be always synchronized with the time server 120.

Each communication IF unit 208 has the function of notifying the CPU 201 of link-down in a case where the communication cable for the communication path 110 to which the communication IF unit 208 itself is connected has been disconnected. Since, even during link-down, the communication IF unit 208 continues a normal operation, a packet which has been transferred from the DMA unit 203 to the communication IF unit 208 is normally received by the communication IF unit 208.

The time synchronization control unit 204 contains its own clock which is synchronized with the clock included in the communication IF unit 208, and outputs, for example, a synchronization signal of 1 hertz (Hz) synchronized with its own clock to the image capturing control unit 206. Since four communication IF units 208 include four clocks in total, the time synchronization control unit 204 also internally includes four clocks. The synchronization signal which the time synchronization control unit 204 outputs is synchronized with any one of the internally included clocks. Since the clock included in the communication IF unit 208 is synchronized with the time server 120, the synchronization signal which the time synchronization control unit 204 outputs is also synchronized with the time server 120.

The image capturing control unit 206 performs control of the camera 102. When the camera adapter 101 receives an instruction from the control terminal 180 via the hub 140, the CPU 201 performs setting on the image capturing control unit 206. Then, the image capturing control unit 206 starts outputting of a Genlock signal and Timecode to the camera 102. The Genlock signal and Timecode are generated based on a synchronization signal which is received from the time synchronization control unit 204.

Moreover, the image capturing control unit 206 outputs a part of Timecode as a trigger signal to the image processing unit 205. The trigger signal is also synchronized with the synchronization signal and, in the present exemplary embodiment, occurs with a period equivalent to the image capturing frame rate of the camera 102.

For example, in a case where the image capturing frame rate of a camera adapter 101 which generates a foreground image is 60 frames per second (fps) and the image capturing frame rate of a camera adapter 101 which generates a background image is 30 fps, the periods of the respective occurring trigger signals are 60 Hz and 30 Hz, respectively.

The camera 102 performs image capturing in synchronization with the Genlock signal, and outputs captured image data together with the received Timecode to the image processing unit 205.

The image processing unit 205 performs image processing required for generating a virtual viewpoint image from the captured image data received from the camera 102, and transfers image data obtained as a result of the image processing to the storage unit 202. The image processing which the image processing unit 205 performs is, for example, clipping of, for example, a region serving as a background or a region serving as a foreground.

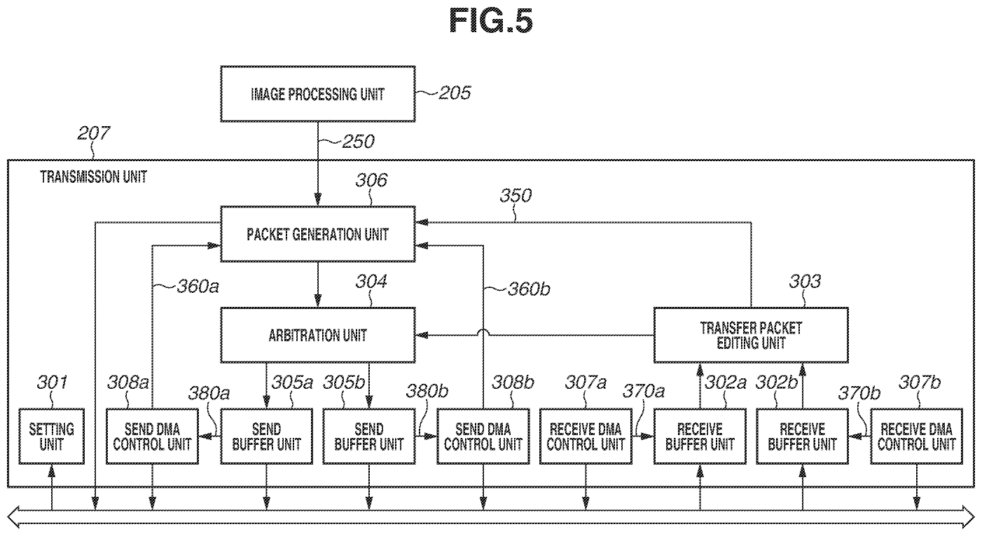

Moreover, at timing when the trigger signal has been received, the image processing unit 205 notifies the transmission unit 207 of information concerning the generated image data via a notification signal 250 (see FIG. 5). The notification signal 250 includes address information indicating a region in which image data is stored in the storage unit 202 for image type such as a foreground image or background image, a data size, and a frame number. These pieces of information included in the notification signal 250 are hereinafter referred to as “notification information”.

Image capturing processing performed by the camera 102 and image processing performed by the image processing unit 205 require overhead for starting each processing operation. Therefore, a notification signal 250 used for notification based on the N-th received trigger signal is not limited to that used for notifying the transmission unit 207 of image data obtained by processing the N-th captured image data received from the camera 102. There is a case where, in consideration of a delay caused by overhead, a notification signal 250 used for notification based on the N-th received trigger signal becomes out of alignment by one or two and is used to notify the transmission unit 207 of image data obtained by performing image processing on the (N-1)th or (N-2)th captured image data.

If the N-th notification signal 250 is used to notify the transmission unit 207 of image data obtained by processing the (N-1)th captured image data, since then, the misalignment between the notification signal 250 and the captured image data does not change.

The transmission unit 207 packetizes image data based on notification information indicated by the notification signal 250 received from the image processing unit 205 to generate an image packet, and issues a transfer instruction for the image packet to the DMA units 203a and 203b on the root side. As a result, the transmission unit 207 receives a notification signal 250 which is generated based on time synchronized with the time server 120 with a period equivalent to the image capturing frame rate, so that a transfer instruction for the image packet also occurs periodically.

Moreover, the transmission unit 207 relays an image packet received from another camera adapter 101. Specifically, the transmission unit 207 takes an image packet sent from another camera adapter 101 on the leaf side in the transmission unit 207 via the DMA units 203c and 203d on the leaf side, and issues a transfer instruction for the image packet to the DMA units 203a and 203b on the root side to send the image packet to a camera adapter 101 on the root side.

The details of generation, sending, and relay of an image packet by the transmission unit 207 are described below.

### Functions of Transmission Unit

FIG. 5 is a functional block diagram illustrating an internal function of the transmission unit 207.

The configuration illustrated in FIG. 5 is an example, and a plurality of functional blocks can be configured to form a single functional block or some functional blocks can be divided into blocks each of which effects a plurality of functions. Moreover, at least one of functional blocks can be implemented as hardware. In a case where hardware is used for implementation, for example, a predetermined compiler can be used to automatically generate a dedicated circuit on an FPGA from a program for implementing the respective steps.

FPGA is an abbreviation for Field Programmable Gate Array. Moreover, in a way similar to FPGA, a gate array circuit can be formed to be implemented as hardware. Moreover, an application specific integrated circuit (ASIC) can be used to be implemented as hardware.

The transmission unit 207 includes a setting unit 301, receive buffer units 302a and 302b, a transfer packet editing unit 303, an arbitration unit 304, send buffer units 305a and 305b, and a packet generation unit 306. Moreover, the transmission unit 207 further includes receive DMA control units 307a and 307b and send DMA control units 308a and 308b.

The setting unit 301 has a register function of retaining control information for the transmission unit 207. The respective functional blocks of the transmission unit 207 are able to acquire control information retained by the setting unit 301, and the CPU 201 sets the control information. The setting unit 301 sets, as the control information, information indicating activation of the transmission unit 207 and transfer destination information indicating the send buffer units 305a and 305b for storing an image packet, with a register. Furthermore, as the transfer destination information, there are transfer destination information concerning an image packet generated by the camera adapter 101 itself and transfer destination information concerning an image packet received from another camera adapter 101.

The setting unit 301 further includes a dedicated register which notifies the transmission unit 207 that link-down has occurred. Furthermore, the setting unit 301 can be configured to manage a plurality of pieces of control information with a single register.

The receive buffer unit 302 has the function of receiving, from the DMA unit 203, an image packet which the communication IF unit 208c or 208d on the leaf side has received and temporarily retaining the image packet and the function of outputting a retained image packet to the transfer packet editing unit 303. An image packet which the receive buffer unit 302 outputs is the oldest image packet out of image packets staying in the buffer of the receive buffer unit 302 itself. Thus, the receive buffer unit 302 outputs image packets in the order of reception thereof. The receive buffer unit 302 starts outputting of the received image packet after receiving a DMA completion notification 370 from the receive DMA control unit 307.

The receive DMA control unit 307 issues a transfer instruction for receiving an image packet to the DMA unit 203c or 203d on the leaf side. The 0-system receive DMA control unit 307a issues the transfer instruction to the 0-system DMA unit 203c, and the 1-system receive DMA control unit 307b issues the transfer instruction to the 1-system DMA unit 203d.

When the CPU 201 activates the transmission unit 207 via the setting unit 301, the receive DMA control unit 307 sets a plurality of transfer instructions to the corresponding DMA unit 203. Then, each time the reception of an image packet is completed, the receive DMA control unit 307 sets a new transfer instruction to the corresponding DMA unit 203, thus maintaining a state in which the reception of an image packet is possible at any time.

Moreover, each time the reception of one image packet is completed, the receive DMA control unit 307 issues a DMA completion notification 370 to the receive buffer unit 302. The DMA completion notification 370 includes data size information indicating the data size of an image packet transferred by DMA. The receive buffer unit 302 is able to determine delimiting of image packets transferred from the DMA unit 203 based on the data size information.

The transfer packet editing unit 303 receives an image packet from the receive buffer unit 302, and outputs the received image packet to the arbitration unit 304. Thus, the transfer packet editing unit 303 receives an image packet via the receive buffer unit 302 and the DMA unit 203.

When outputting the received image packet, the transfer packet editing unit 303 outputs a start notification 350 to the packet generation unit 306 in a case where the received image packet meets a predetermined condition. Moreover, in a case where the received image packet meets the predetermined condition, the transfer packet editing unit 303 performs rewriting of header information about the received image packet, and outputs the image packet with the header information rewritten to the arbitration unit 304. When outputting the received image packet, the transfer packet editing unit 303 appends, to the image packet, transfer destination information indicating to which of the send buffer units 305 to transfer the image packet. As mentioned above, the transfer destination information is managed by the setting unit 301.

The arbitration unit 304 performs arbitration between image packets received from the transfer packet editing unit 303 and the packet generation unit 306 and outputs the arbitrated image packets to the send buffer units 305. Since the received image packet has transfer destination information appended thereto, the arbitration unit 304 allocates the image packet to any one of the two send buffer units 305 with use of the transfer destination information. As a result, the image packet is sent from a communication IF unit 208 corresponding to the send buffer unit 305 to which the image packet has been allocated, out of two communication IF units 208.

The send buffer unit 305 has the function of temporarily retaining an image packet to be transmitted to another camera adapter 101, and, upon receiving an image packet from the arbitration unit 304, issues a DMA start notification 380 to the corresponding send DMA control unit 308. The DMA start notification 380 includes data size information about an image packet stored in the buffer of the send buffer unit 305, and is issued at timing when the last data included in the image packet has been stored in the send buffer unit 305.

In a case where an image packet with last packet information appended thereto has been stored in the send buffer unit 305, the DMA start notification 380 also includes an identifier indicating that the image packet concerned is the last image packet. The last packet information indicates that the image packet concerned is the last image packet of a packet group including one or more image packets to be sent as a series of image packets.

Moreover, in the present exemplary embodiment, the last packet information is used as the above-mentioned start instruction information. In other words, the start instruction information is included in the last image packet of a packet group including one or more image packets to be communicated as a series of image packets. Additionally, the start instruction information is last packet information indicating that an image packet including the start instruction information is the above-mentioned last image packet.

Upon receiving the DMA start notification 380 from the send buffer unit 305, the send DMA control unit 308 issues a transfer instruction for sending an image packet, to the DMA unit 203 on the root side. The 0-system send DMA control unit 308a issues the transfer instruction to the 0-system DMA unit 203a, and the 1-system send DMA control unit 308b issues the transfer instruction to the 1-system DMA unit 203b. Moreover, in a case where the transfer of an image packet responsive to the DMA start notification 380 including an identifier indicating that the image packet concerned is the last image packet has been completed in the DMA unit 203, the send DMA control unit 308 issues a transfer completion notification 360 to the packet generation unit 306.

The packet generation unit 306 controls packet generation with respect to, for example, a background image or foreground image generated by the image processing unit 205. The packet generation unit 306 acquires image data serving as a payload of the image packet via the system bus 209 with use of notification information included in the notification signal 250. The packet generation unit 306 generates an image packet by generating header information and linking up the header information to the image data acquired via the system bus 209.

The generation of an image packet by the packet generation unit 306 is started in response to the occurrence of any one of reception of the start notification 350, time-out of a send start timer internally included in the packet generation unit 306, and setting of a specific time-out time. The time-out time is managed by the setting unit 301.

As with the transfer packet editing unit 303, the packet generation unit 306 appends transfer destination information to the generated image packet and outputs the image packet with transfer destination information appended thereto to the arbitration unit 304. The transfer destination information is managed by the setting unit 301. Moreover, the packet generation unit 306 internally includes a transfer completion counter which measures a time having passed after the DMA transfer of the generated last image packet is completed. In a case where the value of the transfer completion counter is other than “0” and is smaller than a predetermined threshold value, the packet generation unit 306 generates an image packet with a predetermined format and outputs the generated image packet to the arbitration unit 304. The details of an operation of the packet generation unit 306 are described below.

Here, header information about an image packet is described. The header includes, separately from an Ethernet header in the Ethernet frame, a frame number, a camera adapter ID, an image type, an image payload size, an image offset, last data information, and last packet information.

The frame number represents a frame number of each frame in a moving image. For example, if the frame rate is 60 fps, the frame number takes any one of “0” to “59”. In a case where not all of the pieces of image data for one frame are able to be stored in one image packet, the same frame number is appended to a plurality of image packets. A frame number included in the above-mentioned notification signal 250 is used as header information about an image packet.

The camera adapter ID represents a camera adapter 101 which generated the image packet, and is a value specific to each camera adapter 101.

The image type represents a type of image, such as a foreground image or background image, clipped by performing image processing on captured image data.

The image payload size represents a data length of image data included in the image packet.

The image offset represents the amount of offset from the head of image data. If the offset is “0”, the image offset indicates that the data concerned is head data of the image data. In a case where image data for one frame is not able to be stored in one image packet, the image data is divided into a plurality of image packets, and the offset information is written as position information about divided portions. In the case of dividing image data to generate a plurality of image packets, the packet generation unit 306 performs division in order from the head of the image data. The image processing apparatus 160 uses the image offset of an image packet to load image data onto the internal memory, thus performing reconstruction (reassembling).

The last data information indicates that the image packet concerned is the last image packet for each image type in a frame number L (L being “0” or a positive integer). If the value of the last data information is “1”, the image packet concerned is the last image packet, and, if the value of the last data information is “0”, it indicates that the last data information is already erased.

The last packet information indicates that the image packet concerned is the last image packet with the frame number L. If the value of the last packet information is “1”, the image packet concerned is the last image packet, and, if the value of the last packet information is “0”, it indicates that the last packet information is already erased.

In a case where there are two types of image data, such as a foreground image and a background image, and the frame number has been communicated as “L”, the camera adapter 101 sends two image packets with the value of the last data information being “1” and the frame number being “L”. Moreover, in this case, the camera adapter 101 sends one image packet with the value of the last packet information being “1” and the frame number being “L”.

### Transmission of Image Packet

In the following description, processing which is performed in a case where an image packet is transmitted from the camera adapter 101 to an adjacent camera adapter 101 is described with reference to FIG. 4 and FIG. 5. First, processing which is performed in a case where the camera adapter 101 transmits (transfers) the received image packet to an adjacent camera adapter 101 is described.

An image packet transmitted from a camera adapter 101 adjacent on the leaf side is received by the communication IF unit 208 via the communication path 110. The communication IF unit 208 performs data conversion processing on the received image packet and then outputs the processed image packet to the DMA unit 203. Upon receiving a transfer instruction issued by the receive DMA control unit 307, the DMA unit 203 transfers the received image packet to the receive buffer unit 302. After the transfer of the image packet is completed, the receive DMA control unit 307 outputs a DMA completion notification 370 to the receive buffer unit 302.

The receive buffer unit 302 outputs an image packet for one packet to the transfer packet editing unit 303 based on data size information included in the received DMA completion notification 370. The transfer packet editing unit 303 appends transfer destination information to the received image packet and outputs the image packet with the transfer destination information appended thereto to the arbitration unit 304.

In performing outputting, the transfer packet editing unit 303 analyzes header information about the image packet, and, in a case where the image packet is an image packet including last packet information (i.e., the value thereof being “1”), performs rewriting of the header and issuance of the start notification 350. As rewriting of the header, the transfer packet editing unit 303 rewrites the last packet information as the value “0”, thus substantially deleting the last packet information.

The arbitration unit 304 outputs an image packet received from the transfer packet editing unit 303 to a send buffer unit 305 designated by the transfer destination information. The send buffer unit 305 internally retains the received image packet, and notifies the send DMA control unit 308 with the DMA start notification 380 that DMA is able to be started. The DMA start notification 380 also includes information about the packet length of the image packet.

The send DMA control unit 308, having received the DMA start notification 380, issues a transfer instruction to the corresponding DMA unit 203. The DMA unit 203, having received the transfer instruction, reads out an image packet retained in the send buffer unit 305 based on address information and data size information included in the transfer instruction, and outputs the read-out image packet to the corresponding communication IF unit 208. The communication IF unit 208 converts the received image packet into information which is able to be transmitted onto the communication path 110, and transmits the information obtained by conversion to the adjacent camera adapter 101.

In other words, the image packet received by the transfer packet editing unit 303 is sent by the first communication IF unit 208 included in a plurality of communication IF units 208. Moreover, the received image packet obtained by removing, from the received image packet including last packet information (i.e., start instruction information), the last packet information is sent by the first communication IF unit 208.

Next, transmission of an image packet which is internally generated by the camera adapter 101 is described.

As mentioned above, the packet generation unit 306 starts generation of an image packet in a case where any one of conditions concerning reception of the start notification 350 from the transfer packet editing unit 303, time-out in the internal send start timer, and setting of a specific time-out time is satisfied.

In the case of a camera adapter 101 which has received an image packet from the leaf side, the packet generation unit 306 starts generation of an image packet in response to reception of the start notification 350.

In the case of a camera adapter 101 to which another camera adapter 101 is not connected on the leaf side, the packet generation unit 306 starts generation of an image packet in response to time-out in the send start timer or setting of a specific time-out time.

The image packet generated by the packet generation unit 306 is subjected to transfer destination information being appended thereto and is then output to the arbitration unit 304.

The arbitration unit 304 outputs the image packet to a send buffer unit 305 indicated by the transfer destination information appended to the image packet received from the packet generation unit 306. After that, as with transmission of the received image packet, the generated image packet is transmitted to an adjacent camera adapter 101.

In other words, the image packet generated by the packet generation unit 306 is sent by the above-mentioned first communication IF unit 208 at timing that is based on reception of start instruction information included in the received image packet.

The above-described processing is continued until the camera adapter 101 has completely sent, as an image packet, image data communicated with the notification signal 250. Since an image packet which is sent last includes last packet information (the value thereof being “1”), the received image packet and the generated image packet become a series of image packets, which is transmitted as a packet group.

Thus, the above-mentioned generated image packet, which includes last packet information serving as start instruction information, is sent by the above-mentioned first communication IF unit 208.

### Transmission at the Time of Link-Down

In a case where link-down has been detected in a communication IF unit 208 which is being used for sending of an image packet, the CPU 201 instructs the transmission unit 207 to switch the communication IF units 208. Specifically, in a case where link-down has been detected in the 0-system communication IF unit 208a, an instruction for switching to the 1-system communication IF unit 208b is issued. Conversely, in a case where link-down has been detected in the 1-system communication IF unit 208b, an instruction for switching to the 0-system communication IF unit 208a is issued.

Furthermore, while, in the present exemplary embodiment, the case of the impossibility of sending caused by link-down is illustrated as an example, even in a case where the communication IF unit 208 has become unable to perform sending due to a cause other than link-down, an instruction for switching the communication IF units 208 is issued.

In a case where the communication IF units 208 have been switched during sending of a series of image packets, the transmission unit 207 inputs image packets beginning with an image packet following an image packet already input to the communication IF unit 208 to the switched-to communication IF unit 208. This causes an image packet which is being sent at the time of link-down occurrence to be lost, but subsequent image packets are continued to be transmitted.

In a case where the above-mentioned first communication IF unit 208 has become unable to perform sending during sending of image packets, the transmission unit 207 inputs image packets beginning with an image packet following an image packet already input to the first communication IF unit 208 to the above-mentioned second communication IF unit 208. This causes an image packet including start instruction information to be sent to the second communication IF unit 208.

Accordingly, an image packet having last packet information serving as start instruction information is also transmitted to an adjacent camera adapter 101. As a result, in each camera adapter 101 located on the downstream side in image data transmission, even if link-down occurs on the upstream side, generation and sending of image data are performed.

### Processing Flow

In the following description, the details of processing operations are described with reference to flowcharts.

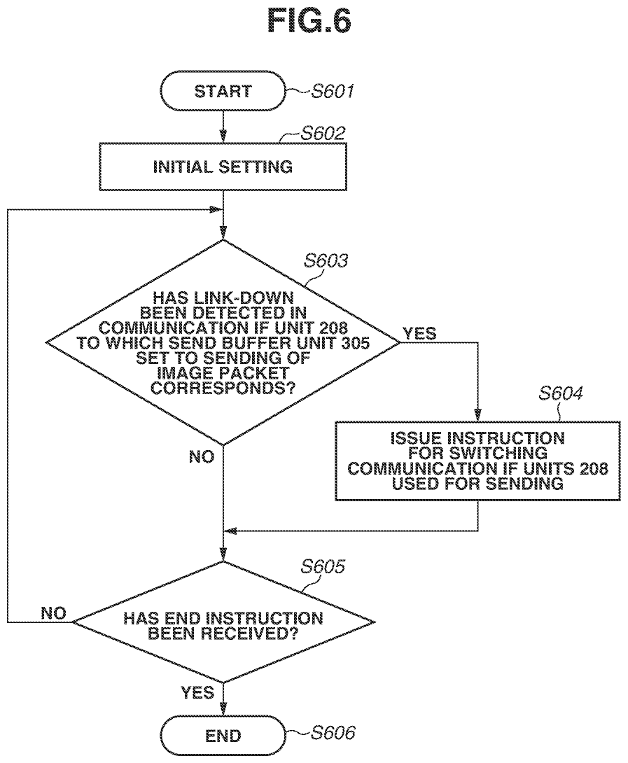

FIG. 6 is a flowchart illustrating control processing for the transmission unit 207 which is performed by the CPU 201.

In step S601, the CPU 201 starts the processing illustrated in FIG. 6 when the camera adapter 101 has been powered on and a driver for the transmission unit 207 has been loaded on the CPU 201.

In step S602, the CPU 201 performs initial setting of the transmission unit 207. The CPU 201 sets, for example, transfer destination information indicating in which system of send buffer unit 305 to store each of a generated image packet and a received image packet, and then advances the processing to step S603.

In step S603, the CPU 201 determines whether the occurrence of link-down has been detected in a communication IF unit 208 to which the send buffer unit 305 determined by the initial setting in step S602 corresponds. The communication IF unit 208 to which the send buffer unit 305 corresponds is the 0-system communication IF unit 208a in the case of the 0-system send buffer unit 305a and is the 1-system communication IF unit 208b in the case of the 1-system send buffer unit 305b. Link-down is detected by being communicated by the communication IF unit 208 to the CPU 201.

If it is determined that the occurrence of link-down has been detected (YES in step S603), then in step S604, the CPU 201 instructs the transmission unit 207 to switch the communication IF units 208 used for sending. Specifically, a change of transfer destination information and a notification of the occurrence of link-down are communicated from the CPU 201 to the setting unit 301 of the transmission unit 207. After the issuance of an instruction for switching the communication IF units 208, the CPU 201 advances the processing to step S605. On the other hand, if it is determined that the occurrence of link-down has not been detected (NO in step S603), the CPU 201 skips step S604 and advances the processing to step S605.

In step S605, the CPU 201 determines whether an end instruction has been received, and, if it is determined that the end instruction has been received (YES in step S605), the CPU 201 advances the processing to step S606, thus ending the processing in the present flow. The end instruction includes, for example, unloading of a driver for the transmission unit 207. On the other hand, if it is determined that the end instruction has not been received (NO in step S605), the CPU 201 returns the processing to the above-mentioned step S603.

With the processing illustrated in FIG. 6, in a case where link-down has occurred in a communication IF unit 208 which is being used for communication, an instruction for switching the communication IF units 208 is issued to the transmission unit 207.

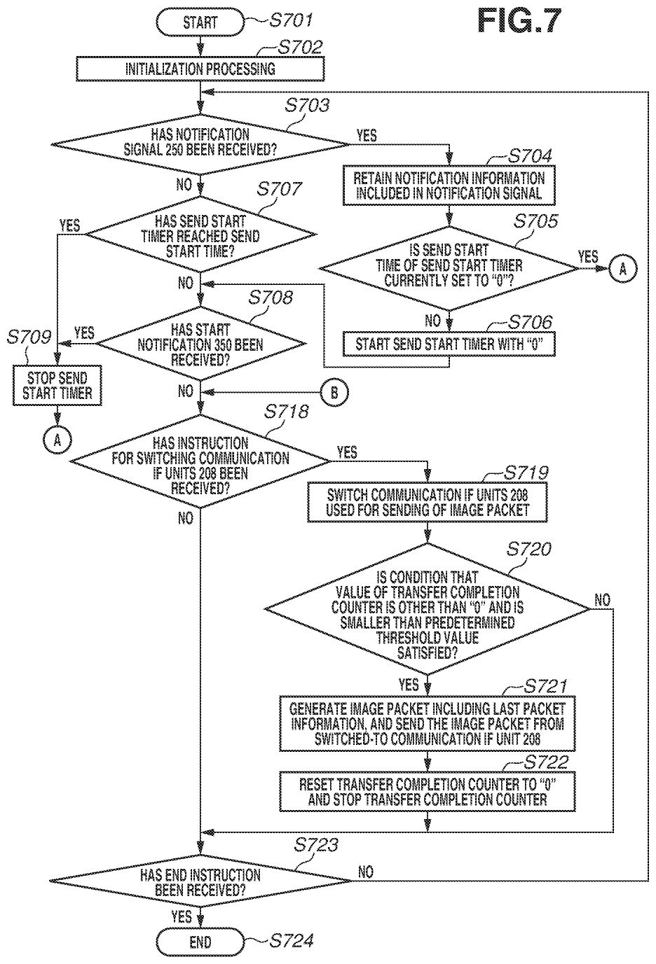

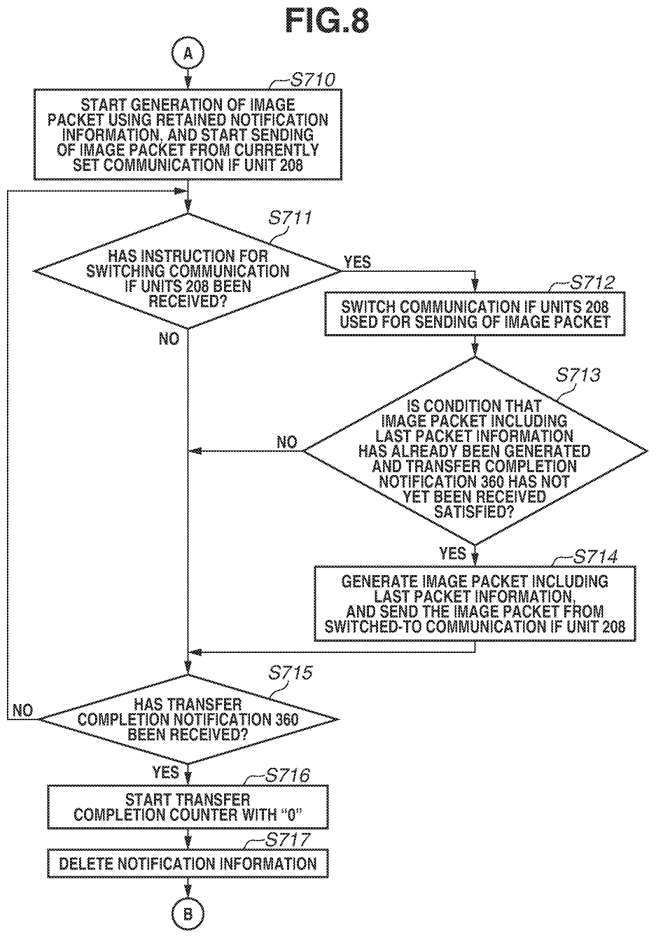

FIG. 7 and FIG. 8 are flowcharts illustrating processing operations concerning generation and sending of an image packet. The circled symbols “A” and “B” illustrated in FIG. 7 are continuous with the circled symbols “A” and “B” illustrated in FIG. 8, respectively.

In step S701, the CPU 201 starts the processing illustrated in FIG. 7 and FIG. 8 in a case where the transmission unit 207 has been activated by the CPU 201 via the setting unit 301.

In step S702, the CPU 201 performs initialization processing on the packet generation unit 306 and the send DMA control unit 308. According to the initialization processing, in the packet generation unit 306, a send start timer and a transfer completion counter included therein are initialized so that their values become “0”.

In step S703, the CPU 201 determines whether the packet generation unit 306 has received the notification signal 250 from the image processing unit 205, and, if it is determined that the notification signal 250 has been received (YES in step S703), then in step S704, the CPU 201 causes the transmission unit 207 to retain notification information included in the notification signal 250, and then advances the processing to step S705.

In step S705, the CPU 201 determines whether send start time of the send start timer is currently set to “0”. The send start time is managed by the setting unit 301 and is set to the setting unit 301 by the CPU 201 when the CPU 201 activates the transmission unit 207. For example, in a camera adapter 101 located at one end on the leaf side in daisy chain connection, the send start time is set to “0”. Moreover, in another camera adapter 101 in daisy chain connection, the send start time is set to a value larger than the period of the notification signal 250.

If, in step S705, it is determined that the send start time is not currently set to “0” (NO in step S705), then in step S706, the CPU 201 starts counting of the send start time with “0”, and then advances the processing to step S708. Furthermore, the send start timer can be designed as a count-down counter. In that case, count-down is started with a value set as the send start time.

If, in the above-mentioned step S703, it is determined that the notification signal 250 has not been received (NO in step S703), then in step S707, the CPU 201 determines whether the send start timer has reached the send start time. The case where the send start timer has reached the send start time is, for example, a case where a predetermined time has passed without an image packet including last packet information being received from another camera adapter 101. This case corresponds to, for example, a case where sending of an image packet has become delayed to a large degree in another camera adapter 101 on the leaf side.

If it is determined that the send start timer has not reached the send start time (NO in step S707), the CPU 201 advances the processing to step S708. In a case where the send start timer is designed as a count-down counter, in step S707, the CPU 201 determines whether the send start timer has reached “0”.

In step S708, the CPU 201 determines whether the packet generation unit 306 has received the start notification 350 from the transfer packet editing unit 303. The case where the start notification 350 has been received is, for example, a case where an image packet including last packet information serving as start instruction information has been received from another camera adapter 101.

If, in step S708, it is determined that the start notification 350 has been received (YES in step S708) and if, in the above-mentioned step S707, it is determined that the send start timer has reached the send start time (YES in step S707), then in step S709, the CPU 201 stops the send start timer, which has been started in step S706, and then advances the processing to step S710. Moreover, if, in the above-mentioned step S705, it is determined that the send start time is currently set to “0” (YES in step S705), the CPU 201 also advances the processing to step S710.

In step S710, the CPU 201 causes the packet generation unit 306 to start generation of an image packet using the notification information retained in step S704. Moreover, the CPU 201 inputs the image packet from the arbitration unit 304 to a send buffer unit 305 designated by the transfer destination information and starts sending of the image packet from the communication IF unit 208. After that, the CPU 201 advances the processing to step S711. The transfer destination information managed by the setting unit 301 results in designating a communication IF unit 208 to be used for sending of the image packet.

In step S711, the CPU 201 determines whether the transmission unit 207 has received an instruction for switching the communication IF units 208 from the CPU 201, i.e., whether link-down has occurred during sending of the image packet.

If, in step S711, it is determined that the instruction for switching has been received (YES in step S711), then in step S712, the CPU 201 switches the communication IF units 208 used for sending of the image packet, and then advances the processing to step S713. Switching of the communication IF units 208 includes, specifically, the packet generation unit 306 rereading transfer destination information managed by the setting unit 301 and appending new transfer destination information to the image packet.

In step S713, the CPU 201 determines whether a condition that an image packet including last packet information has already been generated and the transfer completion notification 360 has not yet been received is satisfied. In a case where the condition is satisfied, the already generated image packet including last packet information is not correctly sent to a camera adapter 101 on the downstream side. This is because the image packet is already input to the communication IF unit 208 which has been used before switching of the communication IF units 208 and the communication IF unit 208 concerned is not able to transmit the image packet due to the occurrence of link-down.

Accordingly, if it is determined that the above-mentioned condition is satisfied (YES in step S713), then in step S714, the CPU 201 causes the packet generation unit 306 to re-generate an image packet including last packet information and causes the image packet to be sent from the communication IF unit 208 which is used after switching of the communication IF units 208. Furthermore, the image packet including last packet information means, as mentioned above, an image packet in which the value of last packet information included in header information about the image packet is “1”.

The image packet to be generated in step S714 does not need to include image data other than header information. This is because, with regard to a captured image in the sensor system 190 concerned, some pieces of image data have become irreparable due to the occurrence of link-down and, even if the image processing apparatus reassembles image data, it is impossible to return the image data to an original image obtained before being fragmented.

Therefore, each packet is sent with a minimum necessary data size in such a manner that the band of the communication path 110 is not wastefully consumed and the last packet information is transmitted to a camera adapter 101 on the downstream side in the shortest time. The minimum necessary data size depends on the standard of the communication IF unit 208 and is 64 bytes in the case of Ethernet. Out of 64 bytes, a frame check sequence using 4 bytes can be generated by the communication IF unit 208.

In other words, in a case where the above-mentioned first communication IF unit 208 has become unable to perform sending during sending of the above-mentioned generated image packet, a packet including start instruction information and not including image data is sent as the above-mentioned communication packet. Additionally, a packet including start instruction information and having a minimum size in the above-mentioned second communication IF unit 208 is sent as the above-mentioned communication packet.

After step S714, the CPU 201 advances the processing to step S715. Moreover, if it is determined that the above-mentioned condition is not satisfied (NO in step S713), the CPU 201 skips step S714 and advances the processing to step S715. Additionally, if, in the above-mentioned step S711, it is determined that the instruction for switching has not been received (NO in step S711), the CPU 201 skips step S712 to step S714 and advances the processing to step S715.

In step S715, the CPU 201 determines whether the packet generation unit 306 has received the transfer completion notification 360 from the send DMA control unit 308, and, if it is determined that the transfer completion notification 360 has been received (YES in step S715), then in step S716, the CPU 201 starts the transfer completion counter with “0” and then advances the processing to step S717. If it is determined that the transfer completion notification 360 has not been received (NO in step S715), the CPU 201 returns the processing to the above-mentioned step S711.

In step S717, the CPU 201 deletes the notification information retained in step S704, and then advances the processing to step S718.

If, in the above-mentioned step S708, it is determined that the start notification 350 has not been received (NO in step S708), the CPU 201 also advances the processing to step S718.

In step S718, as with step S711, the CPU 201 determines whether the transmission unit 207 has received an instruction for switching the communication IF units 208 from the CPU 201.

If, in step S718, it is determined that the instruction for switching has been received (YES in step S718), then in step S719, the CPU 201 switches the communication IF units 208 used for sending of the image packet, and then advances the processing to step S720.

In step S720, the CPU 201 determines whether a condition that the value of the transfer completion counter is other than “0” and is smaller than a predetermined threshold value is satisfied.

The condition to be determined in step S720 means a case where link-down has occurred in an elapsed time within the threshold value after DMA of an image packet including last packet information is completed. In this case, the image packet is deemed not to have been correctly transmitted to a camera adapter 101 on the downstream side.

In other words, even the sending inability state of the above-mentioned first communication IF unit 208 having occurred after the completion of inputting of an image packet to the first communication IF unit 208 is determined to be a sending inability state having occurred during sending of the image packet, as long as before a specific time passes after the completion of inputting.

This is because there is a latency from when the send DMA control unit 308 detects transfer completion for the DMA unit 203 and issues the transfer completion notification 360 to when the communication IF unit 208 actually completes sending of an image packet to an adjacent camera adapter 101. Additionally, there is also a latency from when link-down occurs to when an instruction for switching is transmitted to the transmission unit 207. Accordingly, within an elapsed time equivalent to these latencies, transmission of the image packet may not yet be completed.

If, in step S720, it is determined that the condition is satisfied (YES in step S720), then in step S721, as with step S714, the CPU 201 causes the packet generation unit 306 to re-generate an image packet including last packet information and causes the image packet to be sent from the communication IF unit 208 which is used after switching of the communication IF units 208. After that, in step S722, the CPU 201 resets the transfer completion counter to “0”, thus stopping the transfer completion counter, and then advances the processing to step S723.

If, in step S720, it is determined that the above-mentioned condition is not satisfied (NO in step S720), the CPU 201 skips step S721 and step S722 and advances the processing to step S723. Moreover, if, in the above-mentioned step S718, it is determined that an instruction for switching the communication IF units 208 has not been received (NO in step S718), the CPU 201 skips step S719 to step S722 and advances the processing to step S723.

In step S723, the CPU 201 determines whether an end instruction has been received, and, if it is determined that the end instruction has been received (YES in step S723), the CPU 201 advances the processing to step S724, thus ending the processing in the present flow. On the other hand, if it is determined that the end instruction has not been received (NO in step S723), the CPU 201 returns the processing to the above-mentioned step S703.

With the processing illustrated in FIG. 7 and FIG. 8, if any one of conditions concerning whether setting of send start time is “0”, whether the start notification 350 is received, and whether the send start timer times out is satisfied, the packet generation unit 306 starts generation and sending of image data. Thus, in the present exemplary embodiment, even before reception of the start instruction information, in a case where a specific condition is satisfied, sending of the above-mentioned generated image packet is started.

In a case where link-down has occurred (i.e., an instruction for switching the communication IF units 208 has been received from the CPU 201), the packet generation unit 306 continues the processing with use of the switched-to communication IF unit 208. In a case where the instruction for switching has been received at predetermined timing, the packet generation unit 306 determines that the generated image packet including last packet information is not correctly sent to a camera adapter 101 on the downstream side. Then, the packet generation unit 306 generates an image packet including last packet information and sends the generated image packet from the switched-to communication IF unit 208. As a result, the last packet information is transmitted to the camera adapter 101 on the downstream side.

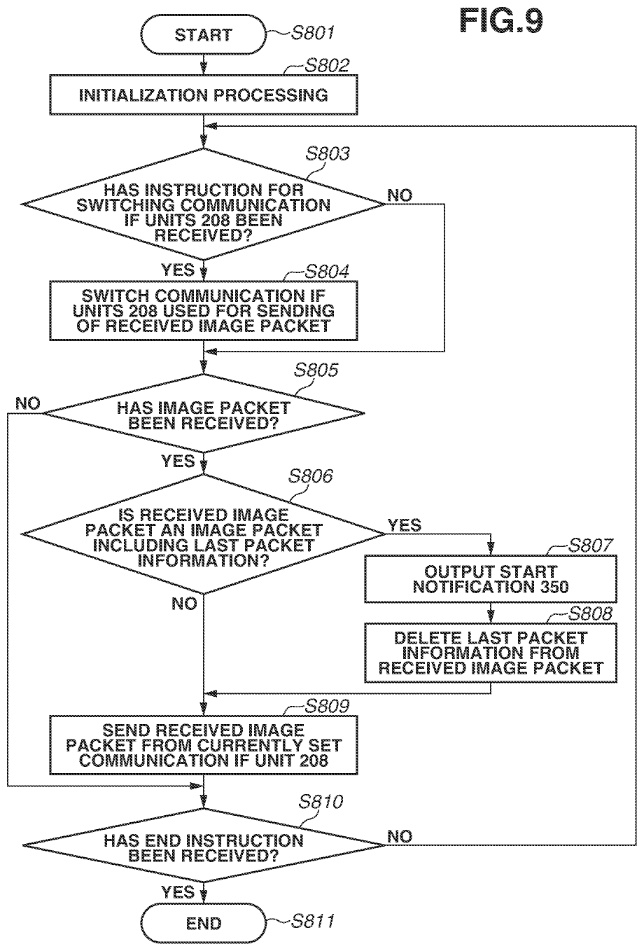

FIG. 9 is a flowchart illustrating a processing operation concerning transfer of a received image packet.

In step S801, the CPU 201 starts the processing illustrated in FIG. 9 in a case where the transmission unit 207 has been activated by the CPU 201 via the setting unit 301.

In step S802, the CPU 201 performs initialization processing for the receive DMA control unit 307, and advances the processing to step S803. In the initialization processing, the receive DMA control unit 307 sets a plurality of transfer instructions to the DMA unit 203. This causes an image packet received by the communication IF unit 208 to be promptly transferred to the receive buffer unit 302 of the transmission unit 207.

In step S803, the CPU 201 determines whether the transmission unit 207 has received an instruction for switching the communication IF units 208 from the CPU 201.

If, in step S803, it is determined that the instruction for switching has been received (YES in step S803), then in step S804, the CPU 201 causes the transfer packet editing unit 303 to switch the communication IF units 208 used for sending of an image packet, and advances the processing to step S805. Switching of the communication IF units 208 includes, specifically, the transfer packet editing unit 303 rereading transfer destination information managed by the setting unit 301 and appending new transfer destination information to the image packet.

If, in step S803, it is determined that the instruction for switching has not been received (NO in step S803), the CPU 201 skips step S804 and advances the processing to step S805.

In step S805, the CPU 201 determines whether an image packet has been received from an adjacent camera adapter 101. If it is determined that the image packet has been received (YES in step S805), then in step S806, the CPU 201 determines whether the received image packet is an image packet including last packet information.

The case where the received image packet is an image packet including last packet information (YES in step S806) means a case where an image packet associated with the current frame number is no longer generated from an upstream camera adapter 101. Therefore, then in step S807, the CPU 201 causes the transfer packet editing unit 303 to output the start notification 350 to the packet generation unit 306, and then advances the processing to step S808. This causes the packet generation unit 306 to start generation and sending of an image packet.

In step S808, the CPU 201 causes the transfer packet editing unit 303 to delete last packet information from the received image packet, and then advances the processing to step S809. Deleting last packet information means setting the value of last packet information included in header information about the image packet to “0”.

Deletion of last packet information results in an image packet received from an upstream camera adapter 101 and an image packet generated by the current camera adapter 101 itself being sent as a series of image packets serving as a packet group to the downstream side.

If, in the above-mentioned step S806, it is determined that the received image packet is not an image packet including last packet information (NO in step S806), the CPU 201 skips step S807 and step S808 and advances the processing to step S809.

In step S809, the CPU 201 causes the received image packet to be sent from the communication IF unit 208 designated by the transfer destination information, and then advances the processing to step S810.

If, in the above-mentioned step S805, it is determined that the image packet has not been received (NO in step S805), the CPU 201 skips step S806 to step S809, and then advances the processing to step S810.

In step S810, the CPU 201 determines whether an end instruction has been received, and, if it is determined that the end instruction has been received (YES in step S810), then in step S811, the CPU 201 ends the processing in the present flow. On the other hand, if it is determined that the end instruction has not been received (NO in step S810), the CPU 201 returns the processing to the above-mentioned step S803.

According to the above-described processing operation, upon receiving a notification indicating that link-down has occurred, the transmission unit 207 of the synchronous image capturing system 100 switches the communication IF units 208 used for sending of an image packet. As a result, image packets staring with an image packet following the image packet which has been in the process of being sent during the occurrence of link-down are sent by the switched-to communication IF unit 208.

Additionally, in such a manner that generation and sending of an image packet are surely performed even in a camera adapter 101 on the downstream side, in a specific case, the transmission unit 207 re-generates an image packet including last packet information and sends the re-generated image packet from the switched-to communication IF unit 208. The specific case is a case where the timing at which an instruction for switching the communication IF units 208 is received is critical timing at which an image packet including last packet information is being sent.

In other words, in a case where, during sending of the above-mentioned received image packet or the above-mentioned generated image packet from the above-mentioned first communication IF unit 208, the first communication IF unit 208 has become unable to perform sending, a communication packet including at least start instruction information is sent. The communication packet is transmitted by the second communication IF unit 208 included in a plurality of communication IF units 208.

Accordingly, even in a case where link-down has occurred during sending of an image packet, out of images for one frame, although some images of a packet which has been in the process of being sent are lost, the other images become transmitted to the downstream side, so that information loss is prevented or reduced.

Furthermore, while, in the above description, an example in which generation and sending of an image packet are started in a case where the packet generation unit 306 has received the start notification 350 is illustrated, generation of an image packet (i.e., packetization) can be started before reception of the start notification 350. Generation of an image packet is unconditionally started, for example, if the packet generation unit 306 has received the notification signal 250. However, sending of an image packet is performed at timing similar to that in the above-described processing. Moreover, a memory which stores the generated image packet until the time of sending thereof can be included in the transmission unit 207 or can be the storage unit 202.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-206110 filed Dec. 23, 2022, which is hereby incorporated by reference herein in its entirety.

What is claimed is:

1. A communication control apparatus comprising:
a generation unit configured to generate an image packet;
a receiving unit configured to receive an image packet;
a first sending unit configured to cause a first image packet received by the receiving unit to be sent by a first communication interface included in a plurality of communication interfaces;
a second sending unit configured to cause a second image packet generated by the generation unit to be sent by the first communication interface at timing that is based on reception of predetermined information included in the first image packet; and
a control unit configured to, in a case where the first communication interface has become unable to perform sending during sending of the first image packet or the second image packet from the first communication interface, cause a communication packet including at least the predetermined information to be sent by a second communication interface included in the plurality of communication interfaces.

2. The communication control apparatus according to claim 1, wherein the second sending unit causes the second image packet including the predetermined information to be sent by the first communication interface.

3. The communication control apparatus according to claim 2, wherein the first sending unit causes the first image packet obtained by deleting the predetermined information from the first image packet including the predetermined information to be sent by the first communication interface.

4. The communication control apparatus according to claim 1, wherein the predetermined information is included in a last image packet included in a packet group including one or more image packets which are communicated as a series of image packets.

5. The communication control apparatus according to claim 4, wherein the predetermined information is last packet information indicating that an image packet including the predetermined information is the last image packet.

6. The communication control apparatus according to claim 1, wherein, in a case where a specific condition is satisfied even before reception of th7e predetermined information, the second sending unit causes sending of the second image packet to be started.

7. The communication control apparatus according to claim 1, wherein the control unit determined that even a sending inability state of the first communication interface having occurred after completion of inputting of an image packet to the first communication interface is a sending inability state having occurred during sending of the image packet, as long as before a specific time passes after the completion of inputting.

8. The communication control apparatus according to claim 1,
wherein each of the first sending unit and the second sending unit inputs an image packet to the first communication interface, thus causing the image packet to be sent from the first communication interface, and
wherein, in a case where the first communication interface has become unable to perform sending during sending of the first image packet or the second image packet, the control unit inputs, to the second communication interface, image packets beginning with an image packet following an image packet already input to the first communication interface, thus causing the communication packet to be sent.

9. The communication control apparatus according to claim 1, wherein, in a case where the first communication interface has become unable to perform sending during sending of the second image packet, the control causes a packet including the predetermined information and not including image data to be sent as the communication packet.

10. The communication control apparatus according to claim 9, wherein the control unit causes a packet including the predetermined information and having a minimum size in the second communication interface to be sent as the communication packet.

11. A communication apparatus comprising:
a communication control apparatus including:
a generation unit configured to generate an image packet;
a receiving unit configured to receive an image packet;
a first sending unit configured to cause a first image packet received by the receiving unit to be sent by a first communication interface included in a plurality of communication interfaces;
a second sending unit configured to cause a second image packet generated by the generation unit to be sent by the first communication interface at timing that is based on reception of predetermined information included in the first image packet;
a control unit configured to, in a case where the first communication interface has become unable to perform sending during sending of the first image packet or the second image packet from the first communication interface, cause a communication packet including at least the predetermined information to be sent by a second communication interface included in the plurality of communication interfaces; and
the plurality of communication interfaces.

12. A communication system comprising a plurality of communication apparatuses each corresponding to the communication apparatus according to claim 11, the plurality of communication apparatuses being connected in daisy chain.

13. A communication control method comprising:
generating an image packet;
receiving an image packet;
causing a received first image packet to be sent by a first communication interface included in a plurality of communication interfaces;
causing a generated second image packet to be sent by the first communication interface at timing that is based on reception of predetermined information included in the first image packet; and
in a case where the first communication interface has become unable to perform sending during sending of the first image packet or the second image packet from the first communication interface, causing a communication packet including at least the predetermined information to be sent by a second communication interface included in the plurality of communication interfaces.

14. A non-transitory computer-readable storage medium storing computer-executable instructions that, when executed by a computer, cause the computer to perform a communication control method comprising:
generating an image packet;
receiving an image packet;
causing a received first image packet to be sent by a first communication interface included in a plurality of communication interfaces;
causing a generated second image packet to be sent by the first communication interface at timing that is based on reception of predetermined information included in the first image packet; and
in a case where the first communication interface has become unable to perform sending during sending of the first image packet or the second image packet from the first communication interface, causing a communication packet including at least the predetermined information to be sent by a second communication interface included in the plurality of communication interfaces.
